(19) United States
(12) Patent Application Publication
(10) Pub. No.: US 2016/0283703 A1
(43) Pub. Date: Sep. 29, 2016

(54) TECHNOLOGIES FOR VERIFYING BIOMETRICS DURING FINGERPRINT AUTHENTICATION

(71) Applicant: Mark Allyn, Portland, OR (US)

(72) Inventor: Mark Allyn, Portland, OR (US)

(21) Appl. No.: 14/671,716

(22) Filed: Mar. 27, 2015

(51) Int. Cl. G06F 21/32; H04W 12/06; H04L 29/06

(52) U.S. Cl. CPC G06F 21/32; H04L 63/0861; H04W 12/06

(57) ABSTRACT

Technologies for authenticating a user include a fingerprint reader device to capture biometric sensor data from the user for authentication. The fingerprint reader device comprises a fingerprint scanner array to capture an image of a fingerprint of a finger of the user and at least one additional biometric sensor to capture biometric data of the user other than the fingerprint. The fingerprint reader device further comprises a finger-receiving surface that includes a lower surface that is recessed relative to an upper surface of the fingerprint reader device. Other embodiments are described herein and claimed.

### BACKGROUND

Typical computing devices may include several technical methods for user authentication. For example, a computing device may support user credential authentication, biometric authentication factors (e.g., fingerprint, facial, voice, and/or retina scanning), security token authentication, or other technical authentication measures. For example, a computing device may provide a fingerprint authentication device (e.g., a fingerprint scanner) for accepting a user's finger and analyzing a fingerprint of the user's finger. The ridges and valleys (i.e., features) of the user's fingerprint may be analyzed and compared against a database of authorized fingerprints (i.e., features) for determining whether the analyzed fingerprint matches a, authorized fingerprint of a user stored at the database. If the analyzed fingerprint is determined to match the authorized fingerprint, the user is typically authorized and granted access to the computing device, or a location in which the computing device may be set up as an access control device.

However, user authentication methods, such as the fingerprint authentication method, may be circumvented, or otherwise compromised, by theft, impersonation, etc. For example, conventional fingerprint scanners provide a flat surface on which a user attempting to authenticate their identity places their finger for analysis. The flat surface typically houses an optical scanner (e.g., a charge coupled device (CCD)) that uses light or a capacitive scanner that uses electrical current to generate an image of the ridges and valleys making up the user's fingerprint. As such, an unauthorized user could use a picture of a fingerprint of an authorized user at an optical scanner or a mold of a fingerprint of an authorized user at a capacitive scanner to fool the fingerprint scanner into allowing an unauthorized user access because the fingerprint matches an authorized fingerprint for an authorized user. In extreme cases, an unauthorized user could dismember a finger from an authorized user. To prevent the fingerprint authorization from being compromised in such a fashion, some fingerprint scanners may additionally include pulse and/or head sensors. However, even such additional biometric inclusions may be overcome, for example, by using a gelatin print model over a finger of the unauthorized user.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for authenticating a user during a fingerprint authentication;

FIG. 2 is a simplified block diagram of at least one embodiment of a computing device of the system of FIG. 1;

FIG. 3 is a simplified block diagram of at least one embodiment of a remote computing device of the system of FIG. 1;

FIG. 4 is a simplified block diagram of at least one embodiment of an environment that may be established by a computing device of FIG. 2;

FIG. 5 is a simplified illustration of a top view of at least one embodiment of a fingerprint reader device that may be used by a computing device of FIG. 2 for capturing biometric data during a fingerprint authentication attempt;

FIG. 6 is a simplified illustration of a front view of at least one embodiment of a fingerprint reader device that may be used by a computing device of FIG. 2 for capturing biometric data during a fingerprint authentication attempt;

FIG. 7 is a simplified illustration of a front view of at least one embodiment of a fingerprint reader device that may be used by a computing device of FIG. 2 for capturing biometric data during a fingerprint authentication attempt of a finger with a mold of an authorized fingerprint attached;

FIG. 8 is a simplified flow diagram of at least one embodiment of a method for capturing biometric authentication data during a fingerprint authentication attempt that may be executed by a computing device of FIG. 2; and

FIG. 9 is a simplified flow diagram of another embodiment of a method for user authentication using biometric authentication data captured during a fingerprint authentication attempt that may be executed by a computing device of FIG. 2 or a remote computing device of FIG. 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

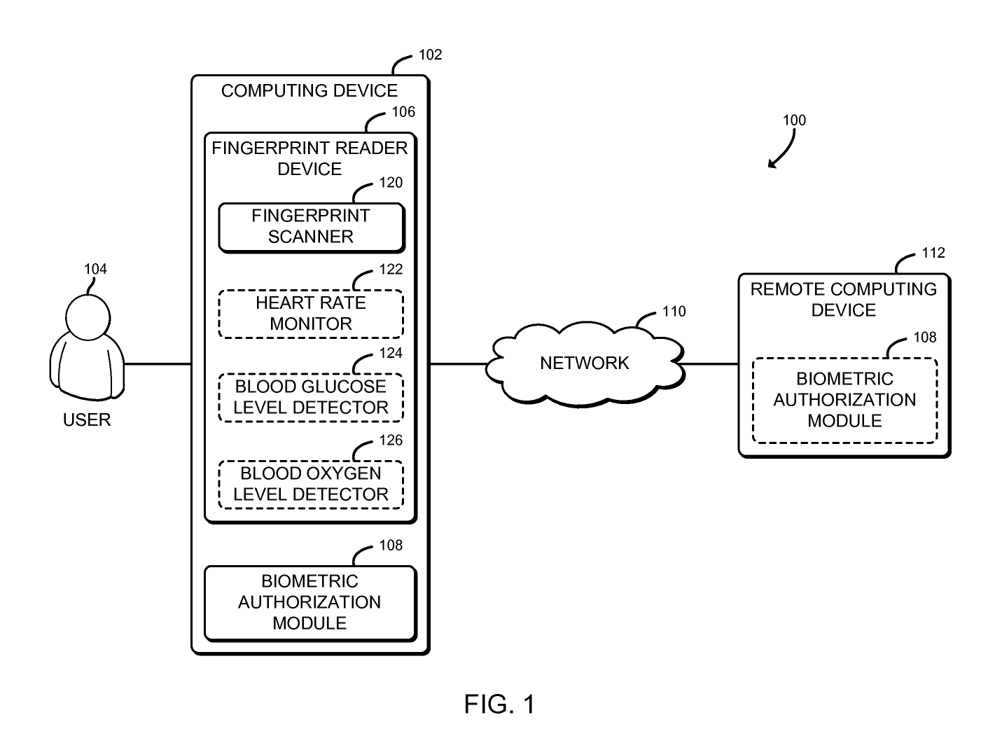

Referring now to FIG. 1, in an illustrative embodiment, a system 100 for authenticating a user during a fingerprint authentication includes a computing device 102 and a remote computing device 112 in communication over a network 110. It should be appreciated, however, that in some embodiments the user authentication during the fingerprint authentication may be performed entirely by the computing device 102. In use, as described in more detail below, the computing device 102 includes a fingerprint reader device 106 and a biometric authorization module 108. The fingerprint reader device 106 is configured to capture biometric data of a user 104 during a fingerprint authentication attempt. The biometric authorization module 108 is configured to perform an analysis on the captured biometric data to determine whether the user 104 is an authorized user and/or detect whether an unauthorized user may be attempting to trick the biometric authorization module 108 into authorizing the unauthorized user.

To capture the biometric data, the fingerprint reader device 106 may include various biometric sensors for retrieving physiological characteristics (i.e., biometric authentication factors) of the user 104. For example, the fingerprint reader device 106 may include a fingerprint scanner 120 to capture an image of a fingerprint of the user 104. In some embodiments, the fingerprint scanner 120 may be comprised of multiple fingerprint scanners forming a fingerprint scanner array. Additionally, unlike conventional, flat fingerprint scanners, at least a portion of the fingerprint reader device 106 may be concave, to allow a finger of the user 104 to be recessed into the concave portion of the fingerprint reader device 106. As such, one or more of the additional biometric sensors may be placed in the recessed portions of the fingerprint reader device 106 to further prevent the unauthorized user from tricking the fingerprint reader device 106.

The fingerprint reader device 106 may additionally include one or more other biometric sensors to prevent an unauthorized user from using a pretense (e.g., a picture of an authorized fingerprint, a mold of an authorized fingerprint, etc.) to trick the computing device 102 into authorizing the unauthorized user. In some embodiments, the other biometric sensors may include a heart rate monitor 122, a blood glucose level detector 124, blood oxygen level detector 126 and/or any other biometric sensor capable of measuring a biometric authentication factor that may be captured by the fingerprint reader device 106 during the fingerprint image capture. In some embodiments, the heart rate monitor 122 may be comprised of a plurality of electrodes capable of measuring an electrical resistance of the finger of the user 104 and/or transmitting/receiving an electrocardiographic (ECG) signal through the finger of the user 104. Additionally or alternatively, in some embodiments, the blood glucose level detector 124 and/or the blood oxygen level detector 126 may be comprised of one or more light emitters for emitting a beam of light from a light source and one or more light collectors, or photodetectors, for capturing the emitted light from a corresponding light emitter. For example, the blood glucose level detector 124 may use a visible light emitter/collector and an infrared light emitter/collector, which the blood glucose level detector 124 may use to measure a light ratio of emitted light collected at the collector of the blood glucose level detector 124. Accordingly, the blood glucose level may be determined from the ratio of collected light. Similarly, the blood oxygen level may be determined by the blood oxygen level detector 126 using an infrared light emitter/collector to measure an infrared light ratio of emitted light collected at the collector of the blood oxygen level detector 126.

The biometric authorization module 108 analyzes the captured fingerprint and data corresponding to the additional biometric authentication factor(s) to determine whether the user 104 is an authorized user. Additionally or alternatively, the biometric authorization module 108 may analyze one or more of the additional biometric authentication factors to determine whether an authorized user is being forced against their will by an unauthorized user (e.g., a tailgater) to authenticate, thereby obtaining access for the unauthorized user. Upon determining the user 104 is an authorized user (i.e., a successful fingerprint authentication) the computing device 102 may allow the user 104 access to the computing device 102, or to a location, for such embodiments in which the computing device 102 is an access control device that controls access to the location.

It should be appreciated that, in some embodiments, the fingerprint authentication may be one of a number of biometric authentications used to authenticate the user 104. For example, in an embodiment wherein the computing device 102 implements a multi-factor authentication, the other biometric authentications may include iris/retinal recognition, voice recognition, DNA, or any other of a number of other physiological characteristics that may be measured and used as a form of identification for the user 104. It should be further appreciated that, in some embodiments, the user 104 may additionally attempt to authenticate to the computing device 102 using additional authentication methods (i.e., non-biometric authentication methods), such as an access card, textual login credentials (e.g., username, password, passphrase, PIN, etc.), and/or a security token.

In use, as will be described in more detail below, the biometric authorization module 108 may be embodied as hardware, firmware, software, or a combination thereof. For example, in some embodiments, the biometric authorization module 108 may be embodied as a special purpose circuit for performing the functions described herein. Additionally or alternatively, in some embodiments of the computing device 102 may establish a secure environment, such as a trusted execution environment (TEE), and monitor the fingerprint reader device 106 from within the secure environment. For example, to protect the privacy and/or security of the data of the user 104, the computing device 102 may apply a machine-learning classification algorithm to the captured data within the secure environment to identify the authenticity of the user 104. Accordingly, by collecting and analyzing potentially sensitive sensor data within a trusted execution environment, privacy of the user 104 may be protected.

The network 110 may be embodied as any type of wired or wireless communication network, including cellular networks (e.g., Global System for Mobile Communications (GSM)), digital subscriber line (DSL) networks, cable networks, telephony networks, local or wide area networks, global networks (e.g., the Internet), or any combination thereof. Additionally, the network 110 may include any number of additional network communication devices (e.g., work stations, routers, switches, hubs, servers, compute devices, store devices, etc.) as needed to facilitate communication between the respective devices of system 100.

As illustrated in FIG. 1, in some embodiments, some or all of the functionality of the biometric authorization module 108 may be located in the computing device 102 or the remote computing device 112. In other words, the captured fingerprint and data related to the additional biometric authentication factors may be collected by the computing device 102 and then transmitted to the remote computing device 112 for analysis and an authentication determination via the network 110. In such embodiments, a secure connection with the remote computing device 112 may be established over the network 110. The computing device 102 may use any technique to establish the secure connection that preserves the security and/or anonymity of biometric data stored by the computing device 102. For example, the computing device 102 may open a connection using the Sign-and-MAC (SIGMA) protocol. Additionally, the computing device 102 may download an authentication determination from the biometric authorization module 108 located at the remote computing device 112 via the secure connection to be used by the computing device 102 to allow or deny access to the user 104.

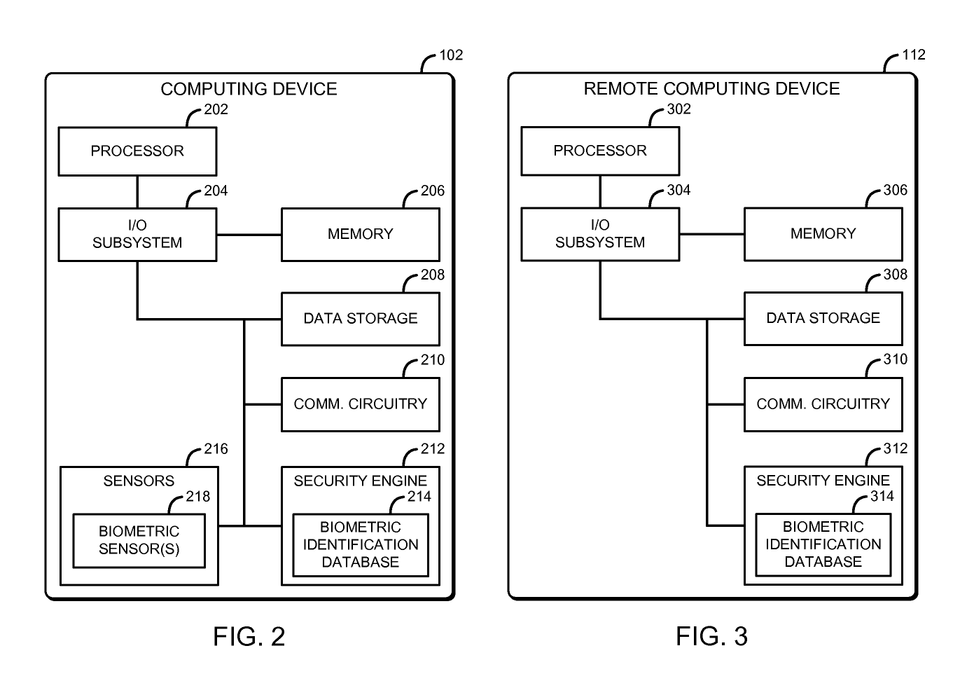

The computing device 102 may be embodied as any type of computation or computer device capable of performing the functions described herein, including, without limitation, a computer, a desktop computer, a workstation, a laptop computer, a notebook computer, a tablet computer, a mobile computing device, a wearable computing device, a network appliance, a web appliance, a distributed computing system, a processor-based system, a consumer electronic device and/or an access control system device. As shown in FIG. 2, the illustrative computing device 102 includes a processor 202, an input/output (I/O) subsystem 204, a memory 206, a data storage device 208, communication circuitry 210, a security engine 212, and a number of sensors 216. Of course, in other embodiments, the computing device 102 may include other or additional components, such as those commonly found in a desktop computer (e.g., various input/output devices) and/or access control. Additionally, in some embodiments, one or more of the illustrative components may be incorporated in, or otherwise form a portion of, another component. For example, the memory 206, or portions thereof, may be incorporated in one or more processors 202 in some embodiments.

The processor 202 may be embodied as any type of processor capable of performing the functions described herein. The processor 202 may be embodied as a single or multi-core processor(s), digital signal processor, microcontroller, or other processor or processing/controlling circuit. The memory 206 may be embodied as any type of volatile or non-volatile memory or data storage capable of performing the functions described herein. In operation, the memory 206 may store various data and software used during operation of the computing device 102 such as operating systems, applications, programs, libraries, and drivers. The memory 206 is communicatively coupled to the processor 202 via the I/O subsystem 204, which may be embodied as circuitry and/or components to facilitate input/output operations with the processor 202, the memory 206, and other components of the computing device 102. For example, the I/O subsystem 204 may be embodied as, or otherwise include, memory controller hubs, input/output control hubs, integrated sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processors 202, the memory 206, and other components of the computing device 102, on a single integrated circuit chip.

The data storage device 208 may be embodied as any type of device or devices configured for short-term or long-term storage of data such as, for example, memory devices and circuits, memory cards, hard disk drives, solid-state drives, or other data storage devices. In some embodiments, the data storage device 208 may be used to store the contents of one or more trusted execution environments. When stored by the data storage device 208, the contents of the trusted execution environments may be encrypted to prevent access by unauthorized software.

The communication circuitry 210 of the computing device 102 may be embodied as any communication circuit, device, or collection thereof, capable of facilitating secure and/or unsecure communications between the computing device 102 and the remote computing device 112 over the network 110. The communication circuitry 210 may be configured to use any one or more communication technology (e.g., wired or wireless communications) and associated protocols (e.g., Ethernet, Bluetooth®, Wi-Fi®, WiMAX, etc.) to effect such communication.

The security engine 212 may be embodied as any hardware component(s) or circuitry capable of establishing a trusted execution environment (TEE) on the computing device 102. In particular, the security engine 212 may support executing code and/or accessing data that is independent and secure from other code executed by the computing device 102. The security engine 212 may be embodied as a Trusted Platform Module (TPM), a manageability engine (ME), an out-of-band processor, or other security engine device or collection of devices. In some embodiments the security engine 212 may be embodied as a converged security and manageability engine (CSME) incorporated in a system-on-a-chip (SoC) of the computing device 102. Further, in some embodiments, the security engine 212 is also capable of communicating using the communication circuitry 210 or a dedicated communication circuit independently of the state of the computing device 102 (e.g., independently of the state of the main processor 202), also known as “out-of-band” communication. The security engine 212 additionally includes a biometric identification database 214 for securely storing biometric identification data, which may be used by the biometric authorization module 108 for performing the authorization.

The sensors 216 include various biometric sensors 218 that are capable of measuring a physiological condition (i.e., biometric data) of the user 104. The biometric sensors 218 may be integrated with or otherwise used by an authentication subsystem of the computing device 102. The biometric sensors 218 may include, for example, various components of the fingerprint reader device 106, such as the fingerprint scanner 120, the heart rate monitor 122, the blood glucose level detector 124, and/or the blood oxygen level detector 126 of FIG. 1. The components of the fingerprint reader device 106 may be embodied as any type of biometric sensors capable of performing the functions described herein. In some embodiments, the fingerprint scanner 120 may be embodied as a charge coupled device (CCD) sensor, a capacitive sensor, or any type of sensor capable of capturing the unique lines and spaces (i.e., ridges and valleys) of a fingerprint of the user 104. Additionally, in some embodiments, the fingerprint scanner 120 may be comprised of more than one fingerprint sensor, forming a fingerprint sensor array.

The heart rate monitor 122 may be embodied as any type of sensor that is capable of detecting the pulse rate of the finger of the user 104 and/or measuring electric resistance of the finger of the user 104. For example, the pulse rate may be detected using multiple electrodes that may be placed around the fingerprint scanner to detect ECG signals from the finger of the user 104. Similarly, the electric resistance may be measured using a number of electrodes capable of transmitting and receiving electrical signals through the finger. In some embodiments, the fingerprint scanner 120 may not be activated until the heart rate monitor has detected a heart rate and/or measured an electrical resistance of the finger that is consistent with an unaltered human finger.

The blood glucose level detector 124 may be embodied as any type of sensor that is capable of detecting a blood glucose level from the finger of the user 104. For example, in some embodiments, the blood glucose level detector 124 may be embodied as optical emitters and collectors that are capable of passing beams of visible light and non-visible light (e.g., beams of visible red light, beams of infrared light, beams of near-infrared light, etc.) from the optical emitters to the optical collectors. The blood oxygen level detector 126 may be embodied as any type of sensor that is capable of detecting a blood oxygen level from the finger of the user 104. For example, in some embodiments, the blood oxygen level detector 126 may be embodied as an emitter that is capable of passing a beam of infrared light, or near-infrared light, to a light collector for collection of the beam of infrared, or near-infrared, light.

It should be appreciated that, in some embodiments, the biometric sensors 218 may additionally include other sensors for additional authentication factors including, but not limited to, a retina scanner, a facial recognition scanner, a voice recognition scanner, a location determination device, etc., which are not shown in FIG. 2 to preserve clarity of the description. Of course, in other embodiments, the computing device 102 may include additional and/or alternative environment sensors.

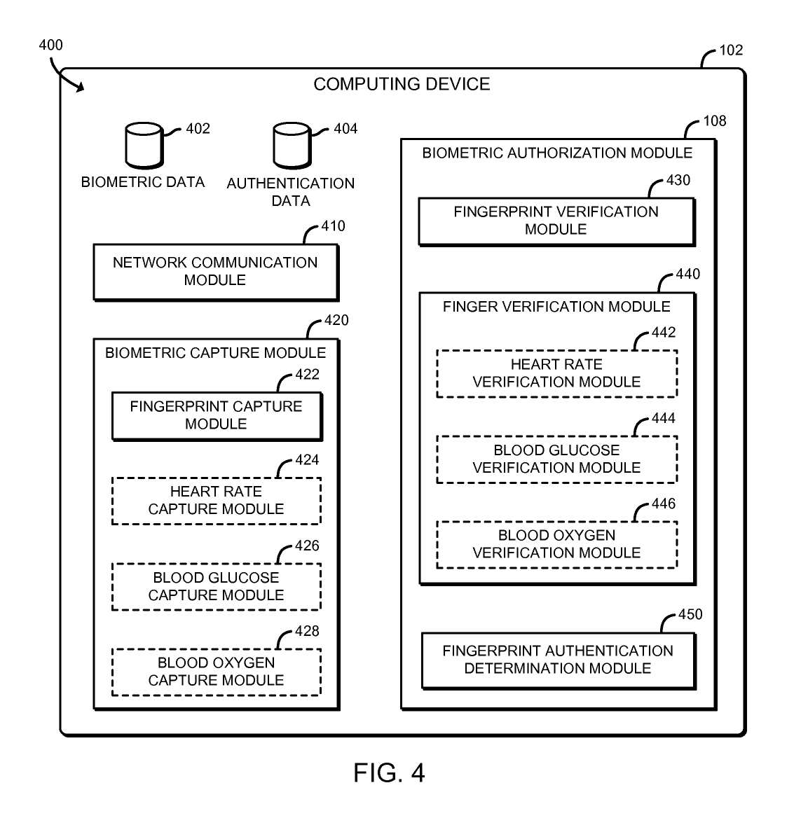

The remote computing device 112 may be embodied as any type of computation or computer device capable of performing the functions described herein, including, without limitation, a computer, a smartphone, a tablet computer, a laptop computer, a notebook computer, a mobile computing device, a wearable computing device, a multiprocessor system, a server (e.g., stand-alone, rack-mounted, blade, etc.), a network appliance (e.g., physical or virtual), a web appliance, a distributed computing system, a processor-based system, and/or a consumer electronic device. In use, the remote computing device 112 is configured to communicate with the computing device 102 over the network 110. Accordingly, as shown in FIG. 3, similar to the computing device 102, the illustrative remote computing device 112 includes a processor 302, an input/output (I/O) subsystem 304, a memory 306, a data storage device 308, communication circuitry 310, and a security engine 312 that includes a biometric identification database 314. As such, further descriptions of the like components are not repeated herein for clarity of the description with the understanding that the description of the corresponding components provided above in regard to the computing device 102 applies equally to the corresponding components of the remote computing device 112.

Referring now to FIG. 4, in use, the computing device 102 establishes an environment 400 during operation. In the illustrative environment 400, the computing device 102 includes a network communication module 410, a biometric capture module 420, and the biometric authorization module 108 of FIG. 1. In some embodiments, the biometric capture module 420 may form a portion of, be connected to, or incorporated within the fingerprint reader device 106 of FIG. 1. The illustrative environment 400 additionally includes biometric data 402 and authentication data 404. The biometric data 402 may include information comprising historically captured the biometric data of an authorized user. For example, the biometric data 402 may include previously captured fingerprint patterns, blood glucose levels (i.e., blood sugar levels), blood oxygen levels, heart rate levels, and/or the like. It should be appreciated, that in some embodiments (e.g., in a multi-factor authentication embodiment), the biometric data 402 may include additional biometric data for supplementary authentication factors (facial recognition, voice recognition, etc.) for authenticating the user 104 based on the biometric sensors 218 of the computing device 102. The authentication data 404 may include non-biometric data, such as an authorized access card identifier, textual login credentials (e.g., username, password, passphrase, PIN, etc.) of an authorized user, etc. It should be appreciated that, in some embodiments, at least a portion of the functionality of the network communication module 410, the biometric capture module 420, and the biometric authorization module 108 may be performed in a hardware or software based trusted execution environment (TEE) that may be configured to provide an isolated and secure execution environment within the environment 400. Additionally or alternatively, the biometric data 402 and/or the authentication data 404 may be stored in a secure environment, such as in the biometric identification database 214 of the security engine 212 illustrated in FIG. 2, or the biometric identification database 314 of the security engine 312 illustrated in FIG. 3.

The various modules of the environment 400 may be embodied as hardware, firmware, software, or a combination thereof. For example, the various modules, logic, and other components of the environment 400 may form a portion of, or otherwise be established by, the processor 202 or other hardware components of the computing device 102. As such, in some embodiments, any one or more of the modules of the environment 400 may be embodied as a circuit or collection of electrical devices (e.g., a network communication circuit, a biometric capture circuit, a biometric authentication circuit, etc.). Additionally or alternatively, in some embodiments, one or more of the illustrative modules may form a portion of another module and/or one or more of the illustrative modules and/or submodules may be embodied as a standalone or independent module.

The network communication module 410 is configured to facilitate network communications from the computing device 102. For example, in some embodiments, such as those embodiments wherein at least a portion of the functionality of the biometric authorization module 108 resides in the remote computing device 112, the network communication module may be configured to facilitate the network communications from the computing device 102 to the remote computing device 112 via one or more various network devices. Accordingly, at least a portion of the functionality of the network communication module 410 may be performed by the communication circuitry 210 of the computing device and/or the communication circuitry 310 of the remote computing device 112.

In use, the biometric capture module 420 is configured to capture biometric sensor data during a fingerprint authentication. In some embodiments, the biometric capture module 420 is configured to capture biometric sensor data received from the fingerprint reader device 106 of FIG. 1. The biometric capture module 420 may be configured to capture biometric fingerprint data from one or more of the biometric sensors 218, such as via the fingerprint scanner 120, the heart rate monitor 122, the blood glucose level detector 124, and/or the blood oxygen level detector 126 of FIG. 1. To do so, the biometric capture module 420 includes a fingerprint capture module 422, a heart rate capture module 424, a blood glucose capture module 426, and/or a blood oxygen capture module 428. It should be appreciated that the biometric capture module 420 may additionally monitor other biometric data of the user 104, such as body temperature, for example, from other sensors or other data sources of the computing device 102 to authenticate the user 104.

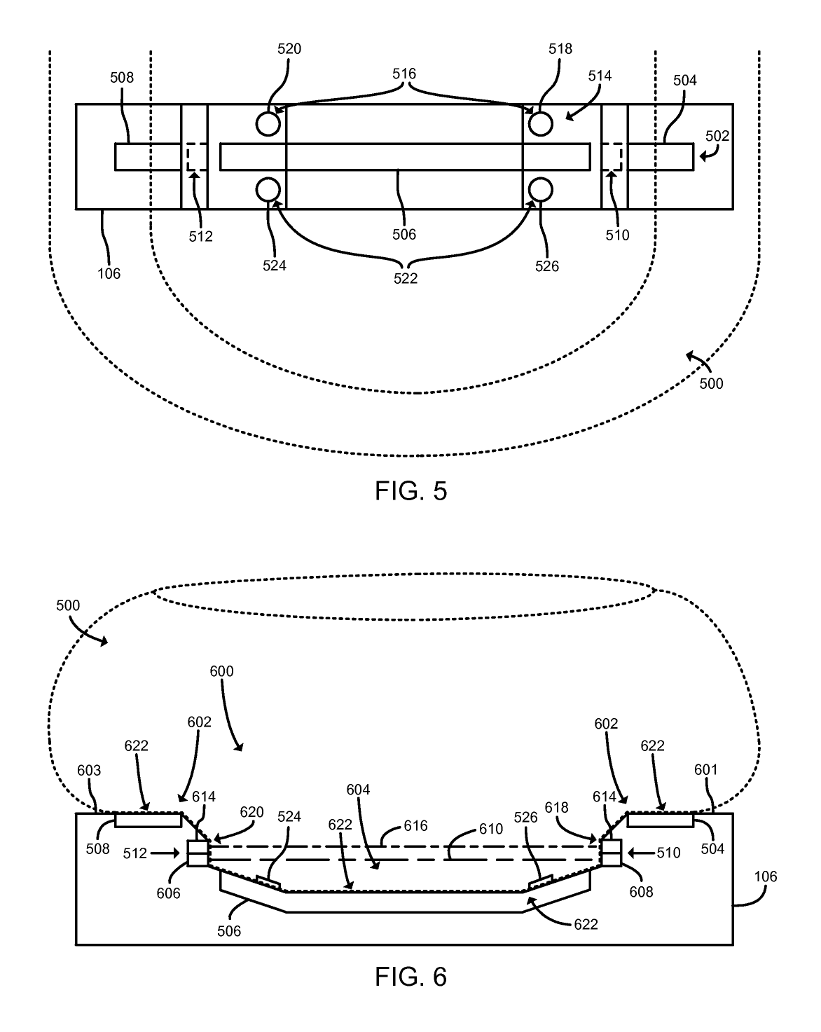

The fingerprint capture module 422 may be configured to capture fingerprint image data from a fingerprint scanner array (i.e., more than one fingerprint scanner), as shown in FIGS. 5 and 6. The heart rate capture module 424 is configured to detect a heart rate of the user 104 attempting to authenticate at the fingerprint reader device 106. The heart rate capture module 424 may be configured to receive electrical signals from one or more electrodes that are in contact with the finger of the user 104 during the authentication attempt. The blood glucose capture module 426 is configured to detect a blood glucose level of the user 104 attempting to authenticate at the fingerprint reader device 106. To do so, in some embodiments, the blood glucose capture module 426 may be configured to receive biometric signals from the blood glucose level detector 124 via a visible light emitter/collector of the blood glucose level detector 124. The blood oxygen capture module 428 is configured to detect a blood oxygen level of the user 104 attempting to authenticate at the fingerprint reader device 106. To do so, in some embodiments, the blood oxygen capture module 428 may be configured to receive biometric signals from the blood oxygen level detector 126 via an infrared light emitter/collector of the blood oxygen level detector 126.

It should be appreciated that each of the heart rate capture module 424, blood glucose capture module 426, and the blood oxygen capture module 428 may be configured to capture, condition, and process the signals sensed by the respective monitor/capture devices to accurately measure the signal. In some embodiments, conditioning and/or processing the signals may include amplifying, filtering, isolating, exciting, quantizing, linearizing, converting, or otherwise manipulating the signals for further processing.

As described previously, the biometric authorization module 108 is configured to analyze sensed biometric data, such as the biometric data captured at the biometric capture module 420, to determine whether a user 104 attempting to authenticate is an authorized user of the computing device 102. The illustrative biometric authorization module 108 includes a fingerprint verification module 430, a finger verification module 440, and a fingerprint authentication determination module 450.

The fingerprint verification module 430 is configured to perform a fingerprint verification. In some embodiments, performing the fingerprint verification may include analyzing an image of the fingerprint of the user 104, identifying one or more features of the fingerprint, and determining whether the identified features of the fingerprint of the user 104 match an authorized user of the computing device 102. The fingerprint verification module 430 may be configured to use any method for performing the fingerprint verification known in the art. In some embodiments, the image may be received from the fingerprint capture module 422 of the biometric capture module 420. Additionally, in some embodiments, the fingerprint features of the authorized users may be stored in the biometric data 402. In some embodiments, the fingerprint verification module 430 may only perform the functions described herein subsequent to a determination that the finger verification module 440 determined that the fingerprint is detected on a live finger (i.e., a liveness verification to ensure the finger belongs to a live user 104), as described further below.

The finger verification module 440 is configured to verify whether the finger the fingerprint is being captured from is an actual finger of the user 104. In other words, the finger verification module 440 is configured to verify the finger, and the fingerprint thereof, being used is not from a mold, a plastic overlay, a glove tip, a finger that has been severed from an authorized user, etc. The finger verification module 440 may include a heart rate verification module 442, a blood glucose verification module 444, and/or a blood oxygen verification module 446. It should be appreciate that, in some embodiments, additional or alternative biometric signals may be used by the computing device 102 to provide a confidence level that the fingerprint is authentic. In some embodiments, the finger verification module 440 may only perform the functions described herein upon a determination that the fingerprint verification module 430 determined that the fingerprint corresponded to an authorized user.

The heart rate verification module 442 may be configured to verify whether a captured heart rate corresponds to a heart rate of an authorized user. In some embodiments, the heart rate of the authorized user may be stored in the biometric data 402, which the heart rate verification module 442 may compare the captured heart rate against to determine whether the user 104 is an authorized user. Additionally or alternatively, in some embodiments, the heart rate verification module 442 may be configured to verify whether the authorized user has an abnormal heart rate, which could be a sign of stress associated with being forced to authenticate at a computing device 102 against the authorized user's will. For example, stress-induced heart rate fluctuations, such as an elevated heart rate and/or reduced electrical resistance detected at the heart rate capture module 424 due to sweating, may indicate the authorized user being forced to authenticate against their will.

The blood glucose verification module 444 may be configured to verify whether a captured blood glucose level corresponds to a blood glucose level of an authorized user. In some embodiments, the blood glucose level of the authorized user may be stored in the biometric data 402, which the blood glucose verification module 444 may compare the captured blood glucose level against to determine whether the user 104 is an authorized user. The blood oxygen verification module 446 may be configured to verify whether a captured blood oxygen level corresponds to a blood glucose level of an authorized user. In some embodiments, the blood oxygen level of the authorized user may be stored in the biometric data 402, which the blood oxygen verification module 446 may compare the captured blood oxygen level against to determine whether the user 104 is an authorized user.

In some embodiments, the heart rate verification module 442, the blood glucose verification module 444, and/or the blood oxygen verification module 446 may use a machine-learning classifier to estimate acceptable thresholds from one authentication attempt to the next of an authorized user. As a result, an acceptable range may be formed for each biometric to be verified. For example, blood glucose levels for a user 104 can fluctuate over time. Accordingly, the machine-learning classifier may use hysteresis to estimate upper and/or lower bounds (i.e., variance thresholds) that may be acceptable blood glucose levels for blood glucose level verification. In some embodiments, the heart rate verification module 442, the blood glucose verification module 444, and/or the blood oxygen verification module 446 may be additionally or alternatively used to perform a liveness verification of the finger of the user 104. In other words, the heart rate verification module 442 may be used to detect a heart rate to determine the finger has a pulse, rather than measure and record the heart rate to compare against a known heart rate of an authorized user. Additionally or alternatively, the blood glucose verification module 444 and/or the blood oxygen verification module 446 may be used to detect liveness (i.e., perform the liveness verification) by detecting a blood glucose level and/or a blood oxygen level, respectively.

The fingerprint authentication determination module 450 is configured to determine whether the captured biometric data corresponds to an authorized user. In some embodiments, the fingerprint authentication determination module 450 may be configured to determine whether the captured biometric data corresponds to an authorized user based on the verification results of the fingerprint verification module 430 and/or the finger verification module 440. In some embodiments, a liveness verification may be performed by the finger verification module 440 before a determination by the fingerprint verification module 430 that the fingerprint of the user 104 matches a fingerprint of an authorized user. Alternatively, in some embodiments, the determination by the fingerprint verification module 430 that the fingerprint of the user 104 matches a fingerprint of an authorized user may require confirmation to be performed by the finger verification module 440 (i.e., a liveness verification).

Referring now to FIGS. 5-7, the illustrative fingerprint reader device 106 includes a fingerprint scanner array 502, a set of light source emitters 510, a set of light collectors 512, and a number of electrodes 514 from which biometric data may be detected and collected. Referring specifically to FIG. 5, from a top view, the illustrative fingerprint scanner array 502 includes a primary fingerprint scanner 506, a left-oriented peripheral fingerprint scanner 504, and a right-oriented peripheral fingerprint scanner 508, wherein each of the fingerprint scanners 504, 508 are oriented relative to the primary fingerprint scanner. Each of the fingerprint scanners 504, 506, 508 may be embodied as any fingerprint scanning device capable of capturing an image of at least a portion of a finger 500 of a user 104.

As shown in FIG. 6, from a front view, the illustrative fingerprint reader device 106 is comprised of a finger-receiving surface 600 that includes an upper surface 602 segmented into an upper-left surface 601 and an upper-right surface 603, and a lower surface 604 having a general “U” shaped curvature (i.e., a generally convex shape) for receiving a pressed-in portion of the finger 500. In the illustrative fingerprint reader device 106, the lower surface 604 is generally recessed below the light source emitters 510 and light collectors 512 on either side to enable the beams of light to be transmitted through at least a portion of the finger 500. Additionally, the primary fingerprint scanner 506 is positioned in the lower surface 604 of the fingerprint reader device 106 extending between the upper-left surface 601 and the upper-right surface 603. Further, the left-oriented peripheral fingerprint scanner 504 is positioned along the upper-left surface 601, while the right-oriented peripheral fingerprint scanner 508 is positioned along the upper-right surface 603. As further shown in FIG. 6, a bottom surface 622 of the finger 500 is pressed onto the fingerprint reader device 106 such that the bottom surface 622 of the finger 500 is in contact with each of the fingerprint scanners 504, 506, 508 of the fingerprint scanner array 502.

It should be appreciated that the peripheral fingerprint scanners 504, 508 are positioned such that the finger 500 can extend beyond the outermost ends (i.e., the ends furthest from the recessed portion) of the peripheral scanners 504, 508 to ensure each of the peripheral scanners 504, 508 captures an image for a portion of the bottom surface 622 of the finger 500. Additionally, it should be further appreciated that additional or alternative fingerprint scanner arrangements may be used in other embodiments. Accordingly, while the upper surface 602 and the lower surface 604 of the fingerprint reader device 106 are shown having defined angles and squared corners, in some embodiments the surfaces of the fingerprint reader device 106 may be at various other angles and/or include rounded corners as may be necessary to accommodate the inserted finger 500 and ensure the finger may maintain contact with each biometric sensing/capturing/measuring component of the fingerprint reader device 106.

Described in further detail below, the light source emitters 510 may be embodied as any light emitting device capable of emitting beams of light in the direction of the light collectors 512. The light collectors 512 may be embodied as any light collecting device capable of collecting beams of light emitted from the light source emitters 510. As shown in FIG. 6, the light source emitters 510 are located on a left sidewall 618 below the upper-left surface 601 and above the lower surface 604, while the light collectors 512 are located on a right sidewall 620 below the upper-right surface 603 and above the lower surface 604 in order to allow the beams of light to be emitted by the light source emitters 510, pass through the finger 500, and be collected by the light collectors 512. While the light source emitters 510 are located on the left sidewall 618 and the light collectors 512 are locate on the right sidewall 620 in the illustrative fingerprint reader device 106, it should be appreciated that one or more of the light source emitters 510 may be located on the right sidewall 620, and similarly one or more of the light collectors 512 may be located on the left sidewall 618, in some embodiments.

In some embodiments, each of the light source emitters 510 may be capable of emitting a light beam at a different portion of the electromagnetic spectrum range. For example, in some embodiments, a visible light source emitter 606 may be configured to emit a light beam 610 of visible light (e.g., visible red) to a visible light collector 608. Additionally or alternatively, an infrared light source emitter 612 may be configured to emit a light beam 616 of infrared light, or near-infrared light, to an infrared light collector 614. Accordingly, a blood glucose level may be determined based on the difference between an amount of light of the light beams 610, 616 emitted from the light source emitters 510 and an amount of light of the light beams 610, 616 collected at the light collectors 512. Similarly, a blood oxygen level may be determined based on the difference between an amount of light emitted from the light source emitters 510 and an amount of light collected at the light collectors 512.

Referring again to FIG. 5, the illustrative electrodes 514 include a first pair of electrodes 516, comprised of electrodes 518, 520, and a second pair of electrodes 522, comprised of electrodes 524, 526. However, it should be appreciated that additional or alternative electrode arrangements including additional or alternative electrodes may be used. The first pair of electrodes 516 may be placed onto the fingerprint reader device 106 such that the finger 500 will be in contact with a portion of the finger below the primary fingerprint scanner 506, while the second pair of electrodes 522 may be placed onto the fingerprint reader device 106 such that the finger 500 will be in contact with a portion of the finger above the primary fingerprint scanner 506. Further, the electrodes 514 may be placed such that the terminating ends (i.e., the ends extending towards the light source emitters 510 and light collectors 512) of the primary fingerprint scanner 506 extend beyond each of the electrode pairs 516, 522.

In some embodiments, each of the electrode pairs 516, 522 may be capable of performing a different function. For example, in some embodiments, the first electrode pair 516 may be configured to perform a resistance measurement, while the second electrode pair 522 may be configured to perform an ECG signal capture. Further, in some embodiments, the fingerprint reader device 106 may randomly determine which of the electrode pairs 516, 522 is to perform which function during any given authorization attempt. While the electrodes 524, 526 are shown protruding from the lower surface 604 of the fingerprint reader device 106 in FIG. 6 for illustrative purposes, it should be appreciated that the electrodes 514 may be placed generally flush along the lower surface 604 of the fingerprint reader device 106 so as not to disrupt contact between the bottom surface 622 of the finger 500 and the lower surface 604.

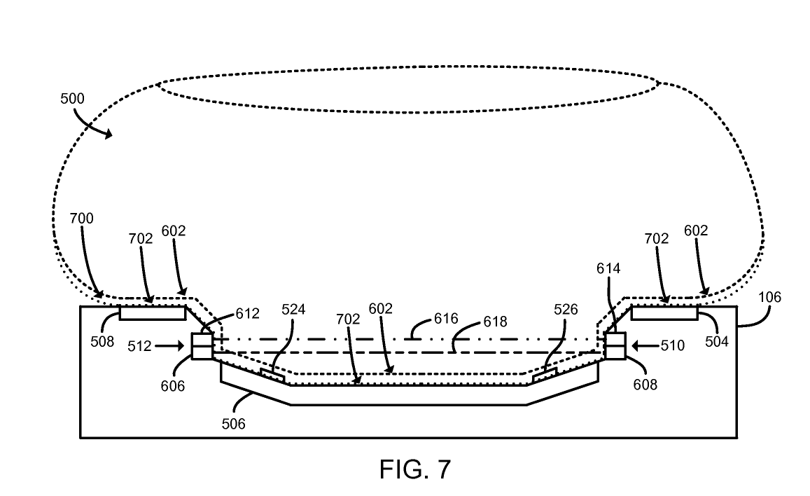

Referring now to FIG. 7, the finger 500 is shown with a mold 700 of an authorized fingerprint attached to the finger 500 of an unauthorized user in an effort to deceive the fingerprint reader device 106 into authorizing the unauthorized user. Accordingly, a bottom surface 702 of the mold 700 may be placed in contact with each of the fingerprint scanners 504, 506, 508 of the fingerprint scanner array 502, as opposed to the bottom surface 622 of the finger 500 of the unauthorized user. While the fingerprint scanner array 502 may capture an image of a fingerprint on the mold 700 that corresponds to an authorized user, the mold 700 is likely to inhibit, or limit, biometric signals from being captured by the other biometric sensors. For example, the mold 700 may block the electrodes 114 from capturing resistance measurements and/or an ECG signal, or otherwise weaken the signals. In another example, the mold 700 may interrupt (i.e., adversely effect, diffuse, weaken, etc.) the transmission of at least a portion of the light beams 610, 616 from being collected at the light collectors 512, which may result in blood glucose level and/or blood oxygen level readings that are inconsistent with the authorized user matching the authorized fingerprint of the mold 700.

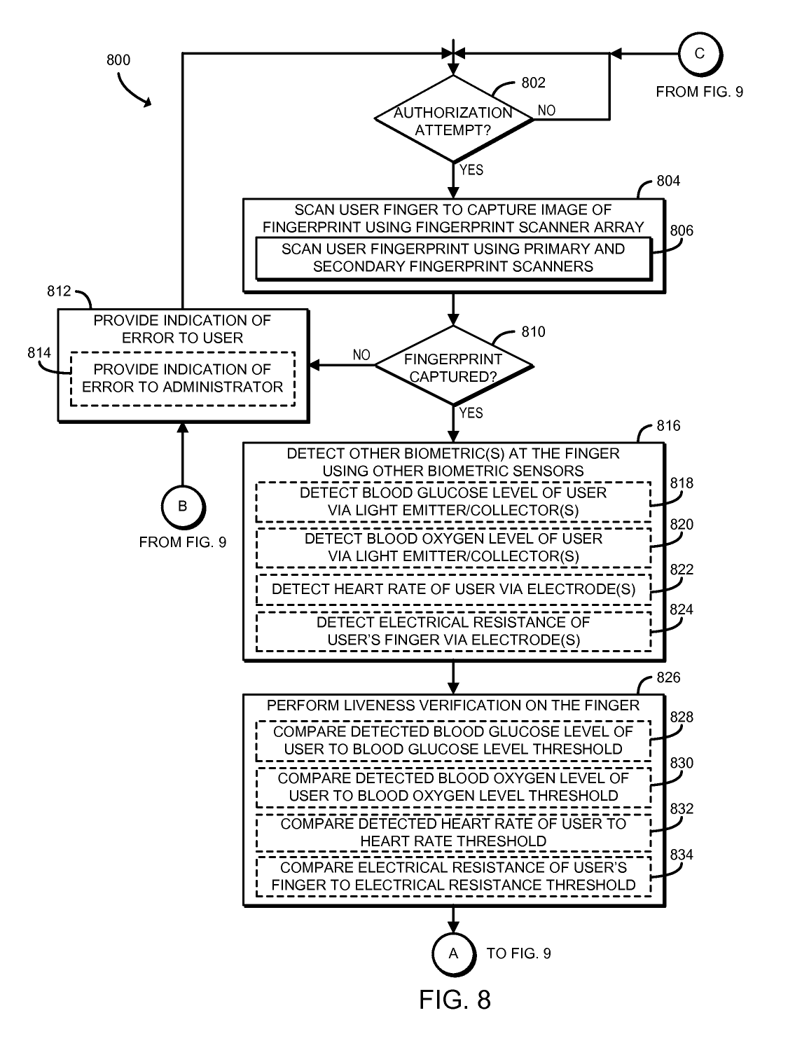

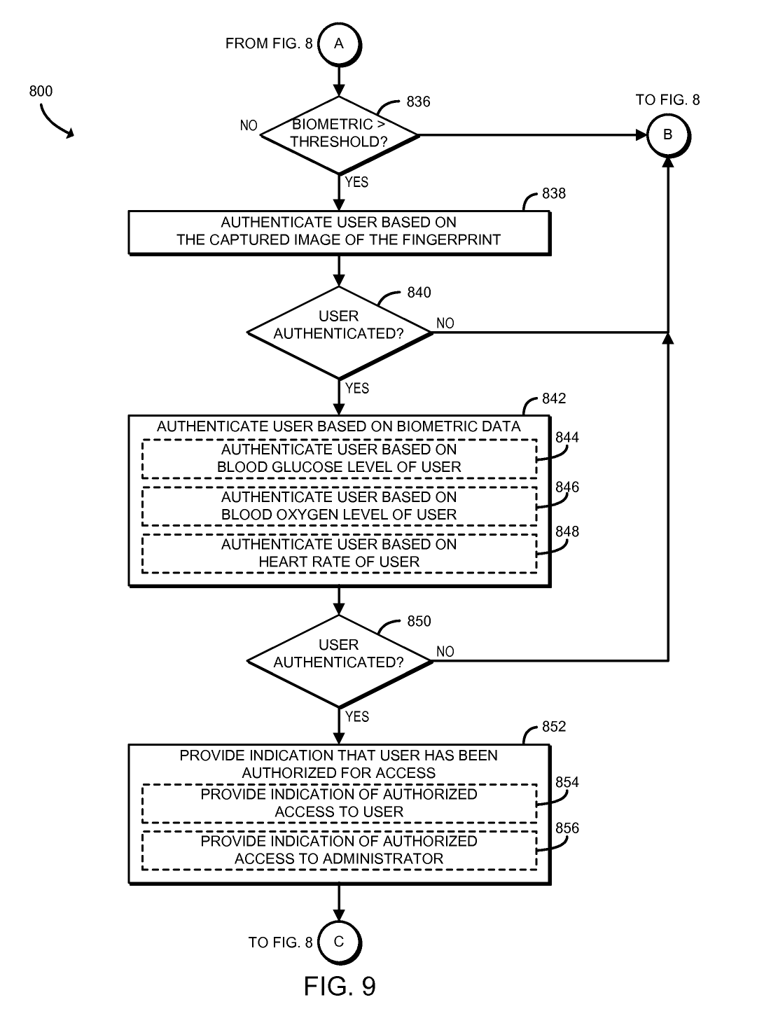

Referring now to FIG. 8, in use, the computing device 102 may execute a method 800 for capturing biometric authentication data of a user (e.g., the user 104) during a fingerprint authentication attempt. Accordingly, at least a portion of the method 800 may be performed by a fingerprint reader device 106 of the computing device 102. The method 800 begins at block 802, in which the computing device 102 determines whether an authorization attempt has been initiated. If not, the method 800 loops back to block 802, wherein the computing device 102 continues to determine whether an authorization attempt has been initiated. If the computing device 102 determines an authorization attempt has been initiated, the method 800 advances to block 804.

At block 804, the computing device 102 scans at least a portion of a finger of the user 104 to capture an image of the portion of the finger scanned using a fingerprint scanner array, such as the fingerprint scanner array 502 of FIG. 5. At block 806, the computing device 102 scans a portion of the finger at the primary fingerprint scanner (e.g., the primary fingerprint scanner 506) and additional portions of the finger at the secondary fingerprint scanners (e.g., the peripheral fingerprint scanners 504, 508).

After scanning the finger at each fingerprint scanner of the fingerprint scanner array, the method 800 advances to block 810, wherein the computing device 102 determines whether an image of the fingerprint was successfully captured. To do so, the computing device verifies whether the image captured corresponds to an image of a fingerprint (i.e., whether features of a fingerprint are identifiable in the captured image). If not, the method 800 advances to block 812. At block 812, the computing device 102 provides an indication of an error to the user 104 before the method 800 loops back to block 802 to determine whether another authorization attempt has been initiated. In some embodiments, at block 814, the computing device 102 additionally or alternatively provides an indication of an error to an administrator, or security monitor, of the computing device 102. If the computing device 102 determines the image of the fingerprint was successfully captured, the method 800 advances to block 816.

At block 816, the computing device 102 detects one or more other biometrics at the user's 104 finger using at least one additional biometric sensor. For example, in some embodiments, at block 818, the computing device 102 detects a blood glucose level of the user 104 using one or more light emitters and one or more corresponding light collectors of the fingerprint reader device 106. Additionally or alternatively, in some embodiments, at block 820, the computing device detects a blood oxygen level of the user determined using one or more light emitters and one or more corresponding light collectors of the computing device 102. In some embodiments, additionally or alternatively, at block 822, the computing device 102 detects a heart rate of the user 104 determined using one or more electrodes of the computing device 102. Additionally or alternatively, in some embodiments, at block 824, the computing device 102 detects an electrical resistance of the finger of the user 104 determined using one or more electrodes of the computing device 102.

At block 826, the computing device 102 performs a liveness verification. That is, the computing device 102 determines whether the detected finger includes biometric characteristics indicative of a finger of a living human. To do so, in some embodiments, the computing device 102 may compare the one or more other biometrics detected at block 816 against a threshold value (e.g., a blood glucose level threshold, a blood oxygen level threshold, a heart rate threshold, an electrical resistance threshold, etc.). Additionally or alternatively, in some embodiments, the computing device may compare the one or more other biometrics detected at block 816 to a corresponding biometric value of that user 104 that was previously measured and stored. In some embodiments, at block 828, the computing device 102 may perform the liveness verification based on the blood glucose level of the user 104 detected at block 818. Additionally or alternatively, in some embodiments, at block 830, the computing device 102 may perform the liveness verification based on the blood oxygen level of the user 104 detected at block 820. In some embodiments, additionally or alternatively, at block 832, the computing device 102 may perform the liveness verification based on the heart rate of the user 104 detected at block 822. Additionally or alternatively, in some embodiments, at block 834, the computing device 102 may perform the liveness verification based on an electrical resistance of the finger of the user 104 detected at block 824.

After performing the liveness verification, the method 800 advances to block 836, wherein the computing device 102 determines whether the biometric used to perform the liveness verification exceeded the threshold value. In other words, the computing device 102 determines whether the liveness verification resulted in the liveness of the finger of the user 104 being verified. If not, the method advances to block 812, wherein the computing device 102 provides an indication of an error to the user 104. If the computing device 102 verified the liveness of the finger, the method advances to block 838, as shown in FIG. 9.

At block 838, the computing device 102 authenticates the user 104 based on the captured image of the fingerprint. As described previously, the authentication may be performed by the biometric authorization module 108 of the computing device 102, of which at least portions of the functionality may be located at the computing device 102 and/or the remote computing device 112. Accordingly, in some embodiments, the biometric data captured at the fingerprint reader device 106 may be transmitted to the remote computing device 112 for performing at least a portion of the user authentication at block 838. In such embodiments, the remote computing device 112 may return an authentication determination to the computing device 102. In other words, in some embodiments, blocks 838 through 848 may be performed by the remote computing device 112.

At block 840, the computing device 102 determines whether the user 104 was authenticated based on the captured image of the fingerprint. To do so, the computing device 102 may use any known means to detect features of the fingerprint and compare the detected features to previously detected features of fingerprints of authorized users. If not, the method 800 advances to block 812, wherein the computing device 102 provides an indication of an error to the user 104. If the computing device 102 determines the user 104 is an authenticated user 104 based on the captured image of the fingerprint, the method 800 advances to block 842.

At block 842, the computing device 102 further authenticates the user 104 based on captured, or measured, biometric data other than the fingerprint. As described previously, to further authenticate the user 104, one or more additional biometrics captured at the user's 104 finger during the fingerprint authentication attempt may be used to provide a level of confidence that the fingerprint of the user 104 is authorized. For example, under certain stress induced conditions, such as when an authorized user is being forced to authenticate their authorized fingerprint to allow an unauthorized user to tailgate behind them, certain biometrics captured during the fingerprint authorization may go beyond an acceptable threshold.

At block 844, the computing device 102 may further authenticate the user 104 based on the blood glucose level of the user 104 detected at block 818. To do so, in some embodiments, the computing device 102 may compare a known blood glucose level for the fingerprint authenticated user against a present blood glucose level captured during the fingerprint authentication attempt. At block 846, the computing device 102 may further authenticate the user 104 based on a blood oxygen level of the user 104 detected at block 820. To do so, in some embodiments, the computing device 102 may compare a known blood oxygen level for the fingerprint authenticated user against a present blood oxygen level captured during the fingerprint authentication attempt. At block 848, the computing device 102 may further authenticate the user 104 based on a heart rate of the user 104 detected at block 822. To do so, in some embodiments, the computing device 102 may compare a known heart rate for the fingerprint authenticated user against a present heart rate captured during the fingerprint authentication attempt.

At block 850, the computing device 102 determines whether the user 104 has been further authenticated based on the captured, or measured, biometric data other than the fingerprint. If not, the method 800 advances to block 812, wherein the computing device 102 provides an indication of an error to the user 104. It should be appreciated that, in some embodiments, the user 104 may be further prompted to provide one or more additional biometrics for authentication, such as voice recognition, face recognition, retina scan, DNA matching, etc., before continuing. For example, under such conditions wherein a user 104 has an authorized fingerprint, but other biometrics captured during the fingerprint authorization are beyond the acceptable threshold, the user 104 may be prompted to provide additional biometrics for authentication.

If the computing device 102 determines the user 104 has been further authenticated, the method advances to block 852. At block 852, the computing device 102 provides an indication that the user 104 has been authorized for access. At block 854, the computing device 102 may provide an indication of authorized access to the user 104. In some embodiments, the indication may be unlocking the computing device 102 or permitting access to a location whose access is controlled by the computing device. At block 856, the computing device 102 may provide an indication of authorized access to the administrator. In such embodiments, for example, the administrator may then manually provide the authorized user 104 access to a location (i.e., unlock/open a door) or trigger the administrator to administer a subsequent check (e.g., a metal detection, a photo identification check, etc.).

### EXAMPLES

Illustrative examples of the technologies disclosed herein are provided below. An embodiment of the technologies may include any one or more, and any combination of, the examples described below.

Example 1 includes a computing device for authenticating a user, the computing device comprising a fingerprint reader device to capture biometric sensor data from the user for authentication, wherein the fingerprint reader device comprises a fingerprint scanner array to capture an image of a fingerprint of a finger of the user and at least one additional biometric sensor to capture biometric data of the user other than the fingerprint; and a biometric authorization module to analyze the captured image and the biometric data to determine whether the user is an authorized user of the computing device, wherein the fingerprint reader device comprises a finger-receiving surface that includes a first upper surface, a second upper surface, and a lower surface extending from the first upper surface to the second upper surface, wherein the lower surface is recessed relative to the first and second upper surfaces, wherein a first fingerprint scanner of the fingerprint scanner array is coupled to the first upper surface, a second fingerprint scanner of the fingerprint scanner array is coupled to the second upper surface, and a third fingerprint scanner of the fingerprint scanner array is coupled to the lower surface.

Example 2 includes the subject matter of Example 1, and wherein the at least one additional biometric sensor comprises a heart rate monitor that includes one or more electrodes to capture electrical signals.

Example 3 includes the subject matter of any of Examples 1 and 2, and wherein the one or more electrodes comprises a first electrode to transmit an electrical signal and a second electrode to receive the electrical signal.

Example 4 includes the subject matter of any of Examples 1-3, and wherein the one or more electrodes comprises at least one electrode to capture an electrocardiograph signal.

Example 5 includes the subject matter of any of Examples 1-4, and wherein the one or more electrodes comprises a first pair of electrodes to detect a pulse rate of the user.

Example 6 includes the subject matter of any of Examples 1-5, and wherein the one or more electrodes comprises a second pair of electrodes to measure an electrical resistance of the finger.

Example 7 includes the subject matter of any of Examples 1-6, and wherein each of the first and second pairs of electrodes are coupled to the lower surface.

Example 8 includes the subject matter of any of Examples 1-7, and wherein the third fingerprint scanner includes a first lateral end and a second lateral end opposite the first lateral end, and wherein each of the first and second pairs of electrodes are coupled to the lower surface at a location between first and second lateral ends of the third fingerprint scanner.

Example 9 includes the subject matter of any of Examples 1-8, and wherein the at least one additional biometric sensor comprises a blood glucose level detector that includes one or more light source emitters and one or more corresponding light collectors.

Example 10 includes the subject matter of any of Examples 1-9, and, wherein the one or more light source emitters and the one or more corresponding light collectors comprises a first light source emitter to emit a beam of visible light, a first light collector to collect the beam of visible light, a second light source emitter to emit a beam of non-visible light and a second light collector to collect the beam of non-visible light.

Example 11 includes the subject matter of any of Examples 1-10, and wherein the first light source emitter and the second light source emitter are coupled to a first sidewall of the lower surface, and wherein the first light collector and the second light collector are coupled to a second sidewall of the lower surface opposite the first sidewall.

Example 12 includes the subject matter of any of Examples 1-11, and wherein the second light source emitter emits a beam of infrared light.

Example 13 includes the subject matter of any of Examples 1-12, and wherein the first light source emitter emits a beam of visible red light.

Example 14 includes the subject matter of any of Examples 1-13, and, wherein the at least one additional biometric sensor comprises a blood oxygen level detector that includes a light source emitter to emit a beam of non-visible light and a light collector to collect the beam of non-visible light.

Example 15 includes the subject matter of any of Examples 1-14, and wherein the light source emitter emits a beam of near-infrared light.

Example 16 includes the subject matter of any of Examples 1-15, and wherein the biometric authorization module is further to verify the captured image is an image of a fingerprint and provide an indication of an error in response to a determination that an image of the fingerprint was not captured.

Example 17 includes the subject matter of any of Examples 1-16, and wherein, in response to a determination that the captured image resulted in an image of the fingerprint, the biometric authorization module is further to (i) verify a liveness of the finger based on the biometric data and (ii) provide an indication of an error in response to a determination that the liveness was not verified.

Example 18 includes the subject matter of any of Examples 1-17, and, wherein to verify the liveness of the finger comprises to determine whether the captured biometric data of the user other than the fingerprint is indicative of a live user.

Example 19 includes the subject matter of any of Examples 1-18, and wherein to determine whether the captured biometric data of the user other than the fingerprint is indicative of a live user comprises to determine the fingerprint is indicative of a live user in response to a determination that a level of the captured biometric data of the user other than the fingerprint is greater than a threshold value.

Example 20 includes the subject matter of any of Examples 1-19, and wherein the threshold value comprises at least one of a blood glucose level threshold, a blood oxygen level threshold, a heart rate threshold, or an electrical resistance threshold.

Example 21 includes the subject matter of any of Examples 1-20, and wherein to analyze the captured biometric sensor data comprises to (i) authenticate the user based on the captured image of the fingerprint and (ii) authenticate the user further based on the biometric data in response to a determination that the captured image of the fingerprint corresponds to a fingerprint of an authenticated the user.

Example 22 includes the subject matter of any of Examples 1-21, and wherein to authenticate the user further based on the biometric data comprises to authenticate the user based on at least one of a blood glucose level, a blood oxygen level, or a heart rate.

Example 23 includes the subject matter of any of Examples 1-22, and wherein the lower surface has a generally U-shaped curvature.

Example 24 includes a method for authenticating a user of a computing device, the method comprising capturing, with a fingerprint scanner array of a fingerprint reader device, biometric sensor data from the user for authentication, wherein capturing the biometric sensor data comprises capturing a fingerprint image of a finger of the user using (i) a first fingerprint scanner of the fingerprint scanner array coupled to a first upper surface of the fingerprint reader device, (ii) a second fingerprint scanner of the fingerprint scanner array coupled to a second upper surface of the fingerprint reader device and (iii) a third fingerprint scanner of the fingerprint scanner array coupled to a lower surface of the fingerprint reader device that extends in a generally convex shape from the first upper surface to the second upper surface; capturing, with at least one additional biometric sensor of the fingerprint reader device, biometric data of the user other than the fingerprint image; and analyzing the captured image and the biometric data of the user to determine whether the user is an authorized user of the computing device.

Example 25 includes the subject matter of Example 24, and wherein capturing the biometric data of the user other than the fingerprint image with the at least one additional biometric sensor comprises capturing the biometric data of the user with a heart rate monitor that includes one or more electrodes to capture electrical signals.

Example 26 includes the subject matter of any of Examples 24 and 25, and wherein capturing the biometric data of the user with the heart rate monitor comprises capturing the biometric data of the user with a heart rate monitor that includes a first electrode to transmit an electrical signal and a second electrode to receive the electrical signal.

Example 27 includes the subject matter of any of Examples 24-26, and wherein capturing the biometric data of the user with the heart rate monitor comprises capturing an electrocardiograph signal with the heart rate monitor.

Example 28 includes the subject matter of any of Examples 24-27, and wherein capturing the biometric data of the user with the heart rate monitor that includes one or more electrodes comprises (i) capturing the biometric data of the user with a first pair of electrodes coupled to the lower surface and (ii) detecting a pulse rate of the user based on the biometric data captured at the first pair of electrodes.

Example 29 includes the subject matter of any of Examples 24-28, and wherein capturing the biometric data of the user with the heart rate monitor that includes one or more electrodes comprises (i) capturing the biometric data of the user with a second pair of electrodes coupled to the lower surface and (ii) measuring an electrical resistance of the finger based on the biometric data captured at the second pair of electrodes.

Example 30 includes the subject matter of any of Examples 24-29, and wherein capturing the biometric data of the user other than the fingerprint image with the at least one additional biometric sensor comprises capturing the biometric data of the user with a blood glucose level detector that includes one or more light source emitters coupled to a first sidewall of the lower surface and one or more corresponding light collectors coupled to a second sidewall of the lower surface opposite the first sidewall.

Example 31 includes the subject matter of any of Examples 24-30, and wherein capturing the biometric data of the user with the blood glucose level detector that includes the one or more light source emitters and the one or more corresponding light collectors comprises capturing the biometric data with a first light source emitter that is capable of emitting a beam of visible light, a first light collector that is capable of collecting the beam of visible light, a second light source emitter that is capable of emitting a beam of non-visible light and a second light collector that is capable of collecting the beam of non-visible light.

Example 32 includes the subject matter of any of Examples 24-31, and wherein capturing the biometric data with the first light source emitter that is capable of emitting the beam of visible light comprises capturing the biometric data with a first light source emitter that is capable of emitting a beam of visible red light.

Example 33 includes the subject matter of any of Examples 24-32, and wherein capturing the biometric data with the second source emitter that is capable of emitting the beam of non-visible light comprises capturing the biometric data with a second source emitter that is capable of emitting a beam of infrared light.

Example 34 includes the subject matter of any of Examples 24-33, and wherein capturing the biometric data of the user other than the fingerprint image with the at least one additional biometric sensor comprises capturing the biometric data of the user with a blood oxygen level detector that includes a light source emitter to emit a beam of non-visible light and a light collector to collect the beam of non-visible light.

Example 35 includes the subject matter of any of Examples 24-34, and wherein capturing the biometric data of the user with the blood oxygen level detector that includes the light source emitter to emit the beam of non-visible light and the light collector to collect the beam of non-visible light comprises capturing the biometric data of the user with the blood oxygen level detector that includes the light source emitter to emit a beam of near-infrared light and the light collector to collect the beam of near-infrared light.

Example 36 includes the subject matter of any of Examples 24-35, and further including capturing the image of the fingerprint from the fingerprint scanner array; and verifying the captured image is an image of a fingerprint; and providing an indication of an error in response to a determination that an image of the fingerprint was not captured.

Example 37 includes the subject matter of any of Examples 24-36, and further including verifying a liveness of the finger, in response to a determination that the captured image resulted in an image of the fingerprint, based on the biometric data; and providing an indication of an error in response to a determination that the liveness was not verified.

Example 38 includes the subject matter of any of Examples 24-37, and wherein verifying the liveness of the finger comprises determining whether the captured biometric data of the user other than the fingerprint is indicative of a live user.

Example 39 includes the subject matter of any of Examples 24-38, and wherein determining whether the captured biometric data of the user other than the fingerprint is indicative of a live user comprises determining the fingerprint is indicative of a live user in response to a determination that a level of the captured biometric data of the user other than the fingerprint is greater than a threshold value.

Example 40 includes the subject matter of any of Examples 24-39, and wherein capturing the biometric data of the user other than the fingerprint image with the at least one additional biometric sensor comprises detecting a blood glucose level, and wherein determining whether the captured biometric data of the user other than the fingerprint is indicative of a live user comprises determining whether the detected blood glucose level is greater than a blood glucose level threshold.

Example 41 includes the subject matter of any of Examples 24-40, and wherein capturing the biometric data of the user other than the fingerprint image with the at least one additional biometric sensor comprises detecting a blood oxygen level, and wherein determining whether the captured biometric data of the user other than the fingerprint is indicative of a live user comprises determining whether the detected blood oxygen level is greater than a blood oxygen level threshold.

Example 42 includes the subject matter of any of Examples 24-41, and wherein capturing the biometric data of the user other than the fingerprint image with the at least one additional biometric sensor comprises detecting a heart rate, and wherein determining whether the captured biometric data of the user other than the fingerprint is indicative of a live user comprises determining whether a detected heart rate is greater than a heart rate threshold.

Example 43 includes the subject matter of any of Examples 24-42, and wherein capturing the biometric data of the user other than the fingerprint image with the at least one additional biometric sensor comprises detecting an electrical resistance, and wherein determining whether the captured biometric data of the user other than the fingerprint is indicative of a live user comprises determining whether the detected electrical resistance is greater than an electrical resistance threshold.

Example 44 includes the subject matter of any of Examples 24-43, wherein analyzing the captured biometric sensor data comprises (i) authenticating the user based on the captured image of the fingerprint and (ii) authenticating the user further based on the biometric data in response to a determination that the captured image of the fingerprint corresponds to a fingerprint of an authenticated the user.

Example 45 includes the subject matter of any of Examples 24-44, and wherein authenticating the user further based on the biometric data comprises authenticating the user based on at least one of a blood glucose level, a blood oxygen level, or a heart rate.

Example 46 includes a computing device comprising a processor; and a memory having stored therein a plurality of instructions that when executed by the processor cause the computing device to perform the method of any of Examples 24-45.

Example 47 includes one or more machine readable storage media comprising a plurality of instructions stored thereon that in response to being executed result in a computing device performing the method of any of Examples 24-45.

Example 48 includes a computing device for authenticating a user of a computing device, the computing device comprising means for capturing, by a fingerprint scanner array of a fingerprint reader device, biometric sensor data from the user for authentication, wherein capturing the biometric sensor data comprises capturing a fingerprint image of a finger of the user using (i) a first fingerprint scanner of the fingerprint scanner array coupled to a first upper surface of the fingerprint reader device, (ii) a second fingerprint scanner of the fingerprint scanner array coupled to a second upper surface of the fingerprint reader device and (iii) a third fingerprint scanner of the fingerprint scanner array coupled to a lower surface of the fingerprint reader device that extends in a generally convex shape from the first upper surface to the second upper surface; means for capturing, with at least one additional biometric sensor of the fingerprint reader device, biometric data of the user other than the fingerprint image; and means for analyzing the captured image and the biometric data of the user to determine whether the user is an authorized user of the computing device.

Example 49 includes the subject matter of Example 48, and wherein the means for capturing the biometric data of the user other than the fingerprint image with the at least one additional biometric sensor comprises means for capturing the biometric data of the user with a heart rate monitor that includes one or more electrodes to capture electrical signals.

Example 50 includes the subject matter of any of Examples 48 and 49, and wherein the means for capturing the biometric data of the user with the heart rate monitor comprises means for capturing the biometric data of the user with a heart rate monitor that includes a first electrode to transmit an electrical signal and a second electrode to receive the electrical signal.

Example 51 includes the subject matter of any of Examples 48-50, and wherein the means for capturing the biometric data of the user with the heart rate monitor comprises means for capturing an electrocardiograph signal with the heart rate monitor.

Example 52 includes the subject matter of any of Examples 48-51, and wherein the means for capturing the biometric data of the user with the heart rate monitor that includes one or more electrodes comprises means for (i) capturing the biometric data of the user with a first pair of electrodes coupled to the lower surface and (ii) detecting a pulse rate of the user based on the biometric data captured at the first pair of electrodes.

Example 53 includes the subject matter of any of Examples 48-52, and wherein the means for capturing the biometric data of the user with the heart rate monitor that includes one or more electrodes comprises means for (i) capturing the biometric data of the user with a second pair of electrodes coupled to the lower surface and (ii) measuring an electrical resistance of the finger based on the biometric data captured at the second pair of electrodes.

Example 54 includes the subject matter of any of Examples 48-53, and wherein the means for capturing the biometric data of the user other than the fingerprint image with the at least one additional biometric sensor comprises means for capturing the biometric data of the user with a blood glucose level detector that includes one or more light source emitters coupled to a first sidewall of the lower surface and one or more corresponding light collectors coupled to a second sidewall of the lower surface opposite the first sidewall.

Example 55 includes the subject matter of any of Examples 48-54, and wherein the means for capturing the biometric data of the user with the blood glucose level detector that includes the one or more light source emitters and the one or more corresponding light collectors comprises means for capturing the biometric data with a first light source emitter that is capable of emitting a beam of visible light, a first light collector that is capable of collecting the beam of visible light, a second light source emitter that is capable of emitting a beam of non-visible light and a second light collector that is capable of collecting the beam of non-visible light.

Example 56 includes the subject matter of any of Examples 48-55, and wherein the means for capturing the biometric data with the first light source emitter that is capable of emitting the beam of visible light comprises means for capturing the biometric data with a first light source emitter that is capable of emitting a beam of visible red light.

Example 57 includes the subject matter of any of Examples 48-56, and wherein the means for capturing the biometric data with the second source emitter that is capable of emitting the beam of non-visible light comprises means for capturing the biometric data with a second source emitter that is capable of emitting a beam of infrared light.

Example 58 includes the subject matter of any of Examples 48-57, and wherein the means for capturing the biometric data of the user other than the fingerprint image with the at least one additional biometric sensor comprises means for capturing the biometric data of the user with a blood oxygen level detector that includes a light source emitter to emit a beam of non-visible light and a light collector to collect the beam of non-visible light.

Example 59 includes the subject matter of any of Examples 48-58, and wherein the means for capturing the biometric data of the user with the blood oxygen level detector that includes the light source emitter to emit the beam of non-visible light and the light collector to collect the beam of non-visible light comprises means for capturing the biometric data of the user with the blood oxygen level detector that includes the light source emitter to emit a beam of near-infrared light and the light collector to collect the beam of near-infrared light.

Example 60 includes the subject matter of any of Examples 48-59, and further including means for capturing the image of the fingerprint from the fingerprint scanner array; and means for verifying the captured image is an image of a fingerprint; and means for providing an indication of an error in response to a determination that an image of the fingerprint was not captured.

Example 61 includes the subject matter of any of Examples 48-60, and further including means for verifying a liveness of the finger, in response to a determination that the captured image resulted in an image of the fingerprint, based on the biometric data; and means for providing an indication of an error in response to a determination that the liveness was not verified.

Example 62 includes the subject matter of any of Examples 48-61, and wherein the means for verifying the liveness of the finger means for comprises means for determining whether the captured biometric data of the user other than the fingerprint is indicative of a live user.

Example 63 includes the subject matter of any of Examples 48-62, and wherein the means for determining whether the captured biometric data of the user other than the fingerprint is indicative of a live user comprises means for determining the fingerprint is indicative of a live user in response to a determination that a level of the captured biometric data of the user other than the fingerprint is greater than a threshold value.

Example 64 includes the subject matter of any of Examples 48-63, and wherein the means for capturing the biometric data of the user other than the fingerprint image with the at least one additional biometric sensor comprises means for detecting a blood glucose level, and wherein the means for determining whether the captured biometric data of the user other than the fingerprint is indicative of a live user comprises means for determining whether the detected blood glucose level is greater than a blood glucose level threshold.

Example 65 includes the subject matter of any of Examples 48-64, and wherein the means for capturing the biometric data of the user other than the fingerprint image with the at least one additional biometric sensor comprises means for detecting a blood oxygen level, and wherein the means for determining whether the captured biometric data of the user other than the fingerprint is indicative of a live user comprises means for determining whether the detected blood oxygen level is greater than a blood oxygen level threshold.

Example 66 includes the subject matter of any of Examples 48-65, and wherein the means for capturing the biometric data of the user other than the fingerprint image with the at least one additional biometric sensor comprises means for detecting a heart rate, and wherein the means for determining whether the captured biometric data of the user other than the fingerprint is indicative of a live user comprises means for determining whether a detected heart rate is greater than a heart rate threshold.

Example 67 includes the subject matter of any of Examples 48-66, and wherein the means for capturing the biometric data of the user other than the fingerprint image with the at least one additional biometric sensor comprises means for detecting an electrical resistance, and wherein the means for determining whether the captured biometric data of the user other than the fingerprint is indicative of a live user comprises means for determining whether the detected electrical resistance is greater than an electrical resistance threshold.

Example 68 includes the subject matter of any of Examples 48-67, and wherein the means for analyzing the captured biometric sensor data comprises means for (i) authenticating the user based on the captured image of the fingerprint and (ii) authenticating the user further based on the biometric data in response to a determination that the captured image of the fingerprint corresponds to a fingerprint of an authenticated the user.

Example 69 includes the subject matter of any of Examples 48-68, and wherein the means for authenticating the user further based on the biometric data comprises means for authenticating the user based on at least one of a blood glucose level, a blood oxygen level, or a heart rate.

1. A computing device for authenticating a user, the computing device comprising:
a fingerprint reader device to capture biometric sensor data from the user for authentication, wherein the fingerprint reader device comprises a fingerprint scanner array to capture an image of a fingerprint of a finger of the user and at least one additional biometric sensor to capture biometric data of the user other than the fingerprint; and
a biometric authorization module to analyze the captured image and the biometric data to determine whether the user is an authorized user of the computing device,
wherein the fingerprint reader device comprises a finger-receiving surface that includes a first upper surface, a second upper surface, and a lower surface extending from the first upper surface to the second upper surface, wherein the lower surface is recessed relative to the first and second upper surfaces,
wherein a first fingerprint scanner of the fingerprint scanner array is coupled to the first upper surface, a second fingerprint scanner of the fingerprint scanner array is coupled to the second upper surface, and a third fingerprint scanner of the fingerprint scanner array is coupled to the lower surface, and wherein the locations of the first fingerprint scanner, second fingerprint scanner, and third fingerprint scanner are fixed relative to each other.

2. The computing device of claim 1, wherein the at least one additional biometric sensor comprises a heart rate monitor that includes one or more electrodes coupled to the lower surface to capture electrical signals.

3. The computing device of claim 2, wherein the one or more electrodes comprises a first electrode to transmit an electrical signal and a second electrode to receive the electrical signal.

4. The computing device of claim 2, wherein the one or more electrodes comprises at least one electrode to capture an electrocardiograph signal.

5. The computing device of claim 2, wherein the one or more electrodes comprises a first pair of electrodes to detect a pulse rate of the user and a second pair of electrodes to measure an electrical resistance of the finger.

6. The computing device of claim 5, wherein the third fingerprint scanner includes a first lateral end and a second lateral end opposite the first lateral end, and wherein each of the first and second pairs of electrodes are coupled to the lower surface at a location between first and second lateral ends of the third fingerprint scanner.

7. The computing device of claim 1, wherein the at least one additional biometric sensor comprises a blood glucose level detector that includes one or more light source emitters and one or more corresponding light collectors.

8. The computing device of claim 7, wherein the one or more light source emitters and the one or more corresponding light collectors comprises a first light source emitter to emit a beam of visible light, a first light collector to collect the beam of visible light, a second light source emitter to emit a beam of non-visible light and a second light collector to collect the beam of non-visible light, and
wherein the first light source emitter and the second light source emitter are coupled to a first sidewall of the lower surface, and wherein the first light collector and the second light collector are coupled to a second sidewall of the lower surface opposite the first sidewall.

9. The computing device of claim 8, wherein the first light source emitter emits a beam of visible red light and the second light source emitter emits a beam of infrared light.

10. The computing device of claim 1, wherein the at least one additional biometric sensor comprises a blood oxygen level detector that includes a light source emitter to emit a beam of non-visible light and a light collector to collect the beam of non-visible light.

11. The computing device of claim 10, wherein the light source emitter emits a beam of near-infrared light.

12. The computing device of claim 1, wherein the biometric authorization module is further to verify the captured image is an image of a fingerprint and provide an indication of an error in response to a determination that an image of the fingerprint was not captured.

13. The computing device of claim 12, wherein, in response to a determination that the captured image resulted in an image of the fingerprint, the biometric authorization module is further to (i) verify a liveness of the finger based on the biometric data, wherein to verify the liveness of the finger comprises to determine whether the captured biometric data of the user other than the fingerprint is indicative of a live user, and (ii) provide an indication of an error in response to a determination that the liveness was not verified.

14. The computing device of claim 13, wherein to determine whether the captured biometric data of the user other than the fingerprint is indicative of a live user comprises to determine the fingerprint is indicative of a live user in response to a determination that a level of the captured biometric data of the user other than the fingerprint is greater than a threshold value, wherein the threshold value comprises at least one of a blood glucose level threshold, a blood oxygen level threshold, a heart rate threshold, or an electrical resistance threshold.

15. The computing device of claim 1, wherein to analyze the captured biometric sensor data comprises to (i) authenticate the user based on the captured image of the fingerprint and (ii) authenticate the user further based on the biometric data in response to a determination that the captured image of the fingerprint corresponds to a fingerprint of an authenticated the user, wherein the biometric data comprises at least one of a blood glucose level, a blood oxygen level, or a heart rate.

16. The computing device of claim 1, wherein the lower surface has a generally U-shaped curvature.

17. One or more non-transitory, computer-readable storage media comprising a plurality of instructions that in response to being executed cause a computing device to:
capture, by a fingerprint scanner array of a fingerprint reader device, biometric sensor data from the user for authentication, wherein to capturing the biometric sensor data comprises to capture a fingerprint image of a finger of the user using (i) a first fingerprint scanner of the fingerprint scanner array coupled to a first upper surface of the fingerprint reader device, (ii) a second fingerprint scanner of the fingerprint scanner array coupled to a second upper surface of the fingerprint reader device and (iii) a third fingerprint scanner of the fingerprint scanner array coupled to a lower surface of the fingerprint reader device that extends in a generally convex shape from the first upper surface to the second upper surface, wherein the locations of the first, second, and third fingerprint scanners are fixed relative to each other;
capture, with at least one additional biometric sensor of the fingerprint reader device, biometric data of the user other than the fingerprint image; and
analyze the captured image and the biometric data of the user to determine whether the user is an authorized user of the computing device.

18. The one or more non-transitory, computer-readable storage media of claim 17, wherein to capture the biometric data of the user other than the fingerprint image with the at least one additional biometric sensor comprises to capture the biometric data of the user with at least one of a blood glucose level detector that includes one or more light source emitters coupled to a first sidewall of the lower surface and one or more corresponding light collectors coupled to a second sidewall of the lower surface opposite the first sidewall and a blood oxygen level detector that includes a light source emitter to emit a beam of near-infrared light and a light collector to collect the beam of near-infrared light.

19. The one or more non-transitory, computer-readable storage media of claim 18, wherein to capture the biometric data of the user other than the fingerprint image with the at least one additional biometric sensor comprises to (i) capture the biometric data of the user with a first pair of electrodes coupled to the lower surface, (ii) detect a pulse rate of the user based on the biometric data captured at the first pair of electrodes, (iii) capture the biometric data of the user with a second pair of electrodes coupled to the lower surface, and (iv) measure an electrical resistance of the finger based on the biometric data captured at the second pair of electrodes.

20. The one or more non-transitory, computer-readable storage media of claim 17, further comprising a plurality of instructions that in response to being executed cause the computing device to determine the fingerprint is indicative of a live user in response to a determination that a level of the captured biometric data of the user other than the fingerprint is greater than a threshold value.

21. The one or more non-transitory, computer-readable storage media of claim 17, wherein to analyze the captured biometric sensor data comprises to (i) authenticate the user based on the captured image of the fingerprint and (ii) authenticate the user further based on the biometric data in response to a determination that the captured image of the fingerprint corresponds to a fingerprint of an authenticated the user.

22. The one or more non-transitory, computer-readable storage media of claim 21, wherein to authenticate the user further based on the biometric data comprises to authenticate the user based on at least one of a blood glucose level, a blood oxygen level, or a heart rate.

23. A method for authenticating a user of a computing device, the method comprising:
capturing, with a fingerprint scanner array of a fingerprint reader device, biometric sensor data from the user for authentication, wherein capturing the biometric sensor data comprises capturing a fingerprint image of a finger of the user using (i) a first fingerprint scanner of the fingerprint scanner array coupled to a first upper surface of the fingerprint reader device, (ii) a second fingerprint scanner of the fingerprint scanner array coupled to a second upper surface of the fingerprint reader device and (iii) a third fingerprint scanner of the fingerprint scanner array coupled to a lower surface of the fingerprint reader device that extends in a generally convex shape from the first upper surface to the second upper surface, wherein the locations of the first, second, and third fingerprint scanners are fixed relative to each other;
capturing, with at least one additional biometric sensor of the fingerprint reader device, biometric data of the user other than the fingerprint image; and
analyzing the captured image and the biometric data of the user to determine whether the user is an authorized user of the computing device.

24. The method of claim 23, further comprising determining the fingerprint is indicative of a live user in response to a determination that a level of the captured biometric data of the user other than the fingerprint is greater than a threshold value.

25. The method of claim 23, wherein analyzing the captured biometric sensor data comprises (i) authenticating the user based on the captured image of the fingerprint and (ii) authenticating the user further based on the biometric data in response to a determination that the captured image of the fingerprint corresponds to a fingerprint of an authenticated the user, and wherein authenticating the user further based on the biometric data comprises authenticating the user based on at least one of a blood glucose level, a blood oxygen level, or a heart rate.
